(19) United States
(12) Patent Application Publication
(10) Pub. No.: US 2024/0367930 A1
(43) Pub. Date: Nov. 7, 2024

(54) MEDIA CONVEYING APPARATUS, CONTROL METHOD, AND NON-TRANSITORY COMPUTER-EXECUTABLE MEDIUM

(71) Applicant: PFU LIMITED, Kahoku-shi (JP)

(72) Inventors: Syuichi MORIKAWA, Kahoku-shi (JP); Kiichiro SHIMOSAKA, Kahoku-shi (JP)

(21) Appl. No.: 18/773,278

(22) Filed: Jul. 15, 2024

Related U.S. Application Data
(63) Continuation of application No. PCT/JP2022/002024, filed on Jan. 20, 2022.

(51) Int. Cl. B65H 7/10; B65H 5/06; B65H 7/14

(52) U.S. Cl. CPC B65H 7/10; B65H 5/06; B65H 7/14; B65H 2553/412; B65H 2601/111

(57) ABSTRACT

A media conveying apparatus includes a media tray, a feed roller, a first media sensor, a second media sensor, and circuitry. The first media sensor is located downstream from the feed roller in a media conveyance direction. The first media sensor is located inside of a side wall of a media conveyance path and outside of a maximum size media supported by the media conveying apparatus placed on the media tray in a direction perpendicular to the media conveyance direction. The second media sensor is located downstream from the first media sensor in the media conveyance direction. The circuitry executes error handling based on a detection result of the medium by the first media sensor and a detection result of the medium by the second media sensor.

### CROSS-REFERENCE TO RELATED APPLICATION

This patent application is a continuation application of International Application No. PCT/JP2022/002024, filed on Jan. 20, 2022, the entire disclosure of which is hereby incorporated by reference herein.

### BACKGROUND

The present disclosure relates to a media conveying apparatus, a control method, and a non-transitory computer-executable medium.

In media conveying apparatuses such as scanners that convey media and image the media, media may be damaged when jammed. In such a media conveying apparatus, it is required to stop the conveyance of media before a media jam occurs.

An image reading apparatus provided with media detecting means is known in the art. The media detecting means is located outside an edge regulation position defined by an edge guide for regulating the position of each edge of a medium placed on a media stacker of the image reading apparatus in the width direction of the medium. When the media detecting means detects a medium, the image reading apparatus determines that the medium is skewed.

A copying machine provided with one line sensor for reading the position of a side edge of a conveyed document is known in the art. The line sensor is provided at a position corresponding to a side edge of a document in the direction of conveyance of the document. The copying machine is also provided with a document skew correction device and a control circuit for the document skew correction device. In the copying machine, the position of a side edge of a document being conveyed is read twice or more at certain intervals of movement, and detection data thereof is input to the control circuit to feed back the result to the skew correction device.

### SUMMARY

In one aspect, a media conveying apparatus includes a media tray, a feed roller, a first media sensor, a second media sensor, and circuitry. The feed roller feeds a medium. The first media sensor is located downstream from the feed roller in a media conveyance direction. The first media sensor is located inside of a side wall of a media conveyance path and outside of a maximum size media supported by the media conveying apparatus placed on the media tray in a direction perpendicular to the media conveyance direction. The second media sensor is located downstream from the first media sensor in the media conveyance direction. The circuitry executes error handling based on a detection result of the medium by the first media sensor and a detection result of the medium by the second media sensor.

In another aspect, a control method for controlling a media conveying apparatus includes feeding a medium with a feed roller and executing error handling based on a detection result of the medium by a first media sensor and a detection result of the medium by a second media sensor. The first media sensor is located downstream from the feed roller in a media conveyance direction. The first media sensor is located inside of a side wall of a media conveyance path and outside of a maximum size media supported by the media conveying apparatus placed on a media tray in a direction perpendicular to the media conveyance direction. The second media sensor is located downstream from the first media sensor in the media conveyance direction.

In another aspect, a non-transitory computer-executable medium stores a plurality of instructions which, when executed by one or more processors of a media conveying apparatus, causes the one or more processors to perform a method. The method includes executing error handling based on a detection result of a medium by a first media sensor and a detection result of the medium by a second media sensor. The first media sensor is located downstream from a feed roller in a media conveyance direction. The first media sensor is located inside of a side wall of a media conveyance path and outside of a maximum size media supported by the media conveying apparatus placed on a media tray in a direction perpendicular to the media conveyance direction. The second media sensor is located downstream from the first media sensor in the media conveyance direction.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a perspective view of a media conveying apparatus according to an embodiment;

FIG. 2 is a diagram illustrating a conveyance passage inside the media conveying apparatus of FIG. 1;

FIG. 3 is a schematic view of second sensors and other components of the media conveying apparatus of FIG. 1;

FIG. 4 is a schematic block diagram illustrating an example configuration of the media conveying apparatus of FIG. 1;

FIG. 5 is a block diagram schematically illustrating a configuration of a storage device and a processing circuit illustrated in FIG. 4;

FIG. 6 is a flowchart illustrating example operations of a media reading process;

FIG. 7 is a flowchart illustrating example operations of a jam determination process;

FIG. 8 is a schematic illustration of an example of a medium conveyed in a skewed orientation;

FIG. 9 is a schematic illustration of an example of a medium conveyed in a skewed orientation;

FIG. 10 is a schematic illustration of an example of a medium conveyed in a skewed orientation;

FIG. 11 is a schematic illustration of an example of a medium conveyed in a skewed orientation;

FIG. 12 is a schematic view of fourth sensors of a media conveying apparatus according to another embodiment;

FIG. 13 is a flowchart illustrating example operations of a jam determination process according to another embodiment;

FIG. 14 is a schematic illustration of an example of a medium for which accumulated skew has occurred;

FIG. 15 is a schematic illustration of an example of a medium for which accumulated skew has occurred;

FIG. 16A and FIG. 16B are schematic views of a second sensor of a media conveying apparatus according to another embodiment;

FIG. 17A and FIG. 17B are schematic views of a second sensor of a media conveying apparatus according to another embodiment; and

FIG. 18 is a schematic diagram illustrating an example configuration of a processing circuit of a media conveying apparatus according to another embodiment.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

A media conveying apparatus, a control method, and a control program according to embodiments of the present disclosure will be described hereinafter with reference to the drawings. The technical scope of the present disclosure, however, is not limited to the embodiments described below but includes all aspects that are within the scope of the appended claims and the equivalents thereof.

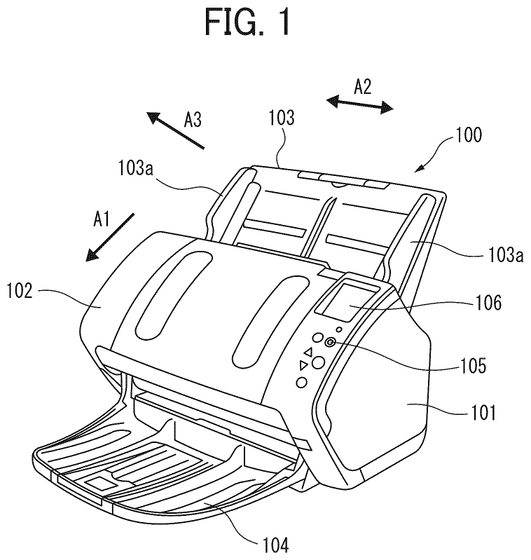

FIG. 1 is a perspective view of a media conveying apparatus 100 as an image scanner. The media conveying apparatus 100 conveys media, which are documents, and images the media. Examples of the media include paper, cardboard, card paper, brochure paper, and passport. Alternatively, the media conveying apparatus 100 may be, for example, a facsimile machine, a copier, or a multifunction peripheral (MFP). The media to be conveyed may be, for example, printing material (e.g., paper sheets) instead of documents. In this case, the media conveying apparatus 100 may be, for example, a printer. In FIG. 1, arrow A1 indicates the direction in which media are conveyed (may be referred to as a “media conveyance direction A1” in the following description). Arrow A2 indicates the width direction of the media conveying apparatus 100 (may be referred to as a “width direction A2” in the following description) perpendicular to the media conveyance direction A1. Arrow A3 indicates the height direction perpendicular to the media conveyance direction A1 and the width direction A2. In the following description, the term “upstream” refers to upstream in the media conveyance direction A1 whereas the term “downstream” refers to downstream in the media conveyance direction A1.

The media conveying apparatus 100 includes a lower housing 101, an upper housing 102, a media tray 103, an ejection tray 104, an operation device 105, and a display device 106.

The upper housing 102 is located at a position covering the upper face of the media conveying apparatus 100, and is engaged with the lower housing 101 via a hinge such that the upper housing 102 can be opened and closed to for example remove a jammed medium or clear the inside of the media conveying apparatus 100.

The media tray 103 is engaged with the lower housing 101, and media to be fed and conveyed are placed on the media tray 103. The media tray 103 is provided with a side guide 103a. The side guide 103a is located on a tray face of the media tray 103 to be movable in the width direction A2. The side guide 103a is positioned in accordance with the width of the media placed on the media tray 103 to regulate the width of the media. In the example illustrated in FIG. 1, two side guides 103a are arranged side by side with a space therebetween in the width direction A2. The number of the side guide 103a may be one.

The ejection tray 104 is engaged with the upper housing 102, and ejected media are placed on the ejection tray 104. The ejection tray 104 may be engaged with the lower housing 101.

The operation device 105 includes an input device such as buttons and an interface circuit that receives signals from the input device. The operation device 105 receives an input operation performed by a user and outputs an operation signal corresponding to the input operation performed by the user. The display device 106 includes a display and an interface circuit that outputs image data to the display, and displays image data on the display. Examples of the display include a liquid crystal display and an organic electroluminescent (EL) display.

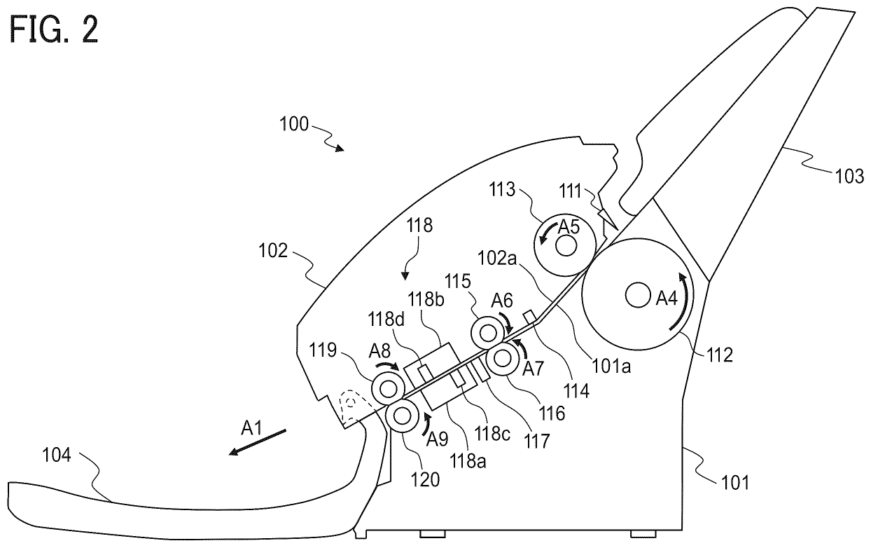

FIG. 2 is a view of the media conveying apparatus 100, illustrating a media conveyance path in the media conveying apparatus 100.

Along the media conveyance path in the media conveying apparatus 100, a first sensor 111, a feed roller 112, a separation roller 113, a second sensor 114, a first conveyance roller 115, a second conveyance roller 116, a third sensor 117, an imaging device 118, a first ejection roller 119, and a second ejection roller 120 are located. The number of each of the feed roller 112, the separation roller 113, the first conveyance roller 115, the second conveyance roller 116, the first ejection roller 119, and/or the second ejection roller 120 is not limited to one but may be two or more. In this case, the two or more rollers of the feed rollers 112, the separation rollers 113, the first conveyance rollers 115, the second conveyance rollers 116, the first ejection rollers 119, and/or the second ejection rollers 120 are aligned and spaced apart in the width direction A2.

The lower housing 101 has an upper face that defines a lower guide 101a of the media conveyance path. The upper housing 102 has a lower face that defines an upper guide 102a of the media conveyance path.

The first sensor 111 is located upstream from the feed roller 112 and the separation roller 113. The first sensor 111 includes a contact detection sensor and detects the presence or absence of one or more media on the media tray 103. The first sensor 111 generates and outputs a first detection signal. The first detection signal has a signal value that changes between a state in which one or more media are placed on the media tray 103 and a state in which no media are placed on the media tray 103. The first sensor 111 is not limited to the contact sensor. The first sensor 111 may be any other sensor that can detect the presence of a medium such as an optical sensor.

The feed roller 112 is located in the lower housing 101. The feed roller 112 separates media placed on the media tray 103 from each other and sequentially feeds the media from below. The separation roller 113 is a so-called brake roller or retard roller and is located in the upper housing 102. The separation roller 113 faces the feed roller 112 and rotates in a direction opposite to the media feed direction. Alternatively, the feed roller 112 may be located in the upper housing 102 whereas the separation roller 113 may be located in the lower housing 101 such that the feed roller 112 feeds the media on the media tray 103 from the top.

The first conveyance roller 115 and the second conveyance roller 116 are located downstream from the feed roller 112 and face each other. The first conveyance roller 115 and the second conveyance roller 116 convey the media, which are placed on the media tray 103 and fed by the feed roller 112 and the separation roller 113, to the imaging device 118.

The imaging device 118 is located downstream from the first conveyance roller 115 and the second conveyance roller 116 and images the media conveyed by the first conveyance roller 115 and the second conveyance roller 116. The imaging device 118 includes a first imaging device 118a and a second imaging device 118b. The first imaging device 118a and the second imaging device 118b face each other with the media conveyance path therebetween.

The first imaging device 118a includes an imaging sensor 118c. The imaging sensor 118c is a contact image sensor (CIS) employing an equal-magnification optical system and includes complementary metal oxide semiconductor (CMOS) imaging elements aligned linearly in the main-scanning direction. The imaging sensor 118c images the front side of a medium being conveyed. The first imaging device 118a further includes a lens and an analog-to-digital (A/D) converter. The lens forms an image on the imaging elements. The A/D converter amplifies electrical signals output from the imaging elements and performs A/D conversion. The first imaging device 118a images the front side of a medium being conveyed to generate an input image and outputs the input image under the control of a processing circuit described below.

The second imaging device 118b includes an imaging sensor 118d. The imaging sensor 118d is a CIS employing an equal-magnification optical system and includes CMOS imaging elements aligned linearly in the main-scanning direction. The imaging sensor 118d images the back side of a medium being conveyed. The second imaging device 118b further includes a lens and an A/D converter. The lens forms an image on the imaging elements. The A/D converter amplifies electrical signals output from the imaging elements and performs A/D conversion. The second imaging device 118b images the back side of a medium being conveyed to generate an input image and outputs the input image under the control of the processing circuit described below.

The media conveying apparatus 100 may include either the first imaging device 118a or the second imaging device 118b to read one side of the medium. Each of the imaging sensor 118c and the imaging sensor 118d may be a CIS imaging sensor employing an equal-magnification optical system including CMOS imaging elements. Alternatively, each of the imaging sensor 118c and the imaging sensor 118d may be a CIS imaging sensor employing an equal-magnification optical system including charge-coupled device (CCD) imaging elements. In another embodiment, the imaging sensors 118c and 118d are each an imaging sensor employing a reduction optical system including CMOS or CCD imaging elements.

The first ejection roller 119 and the second ejection roller 120 are located downstream from the imaging device 118 and face each other. The first ejection roller 119 and the second ejection roller 120 convey the media, which are conveyed by the first conveyance roller 115 and the second conveyance roller 116 and imaged by the imaging device 118, and eject the media to the ejection tray 104.

The media placed on the media tray 103 are conveyed between the lower guide 101a and the upper guide 102a in the media conveyance direction A1 as the feed roller 112 rotates in a direction indicated by arrow A4 in FIG. 2, that is, in the media feed direction. During the conveyance of the media, the separation roller 113 rotates in a direction indicated by arrow A5, that is, in the direction opposite to the media feed direction. Due to the action of the feed roller 112 and the separation roller 113, when a plurality of media is placed on the media tray 103, only the medium in contact with the feed roller 112 among the media placed on the media tray 103 is separated. This prevents the feeding of a medium other than the separated medium. In other words, the multiple feeding is prevented.

The medium is fed into between the first conveyance roller 115 and the second conveyance roller 116 while being guided by the lower guide 101a and the upper guide 102a. As the first conveyance roller 115 and the second conveyance roller 116 rotate in the directions indicated by arrows A6 and A7, respectively, the medium is fed into between the first imaging device 118a and the second imaging device 118b. The medium read by the imaging device 118 is ejected onto the ejection tray 104 as the first ejection roller 119 and the second ejection roller 120 rotate in directions indicated by arrows A8 and A9, respectively.

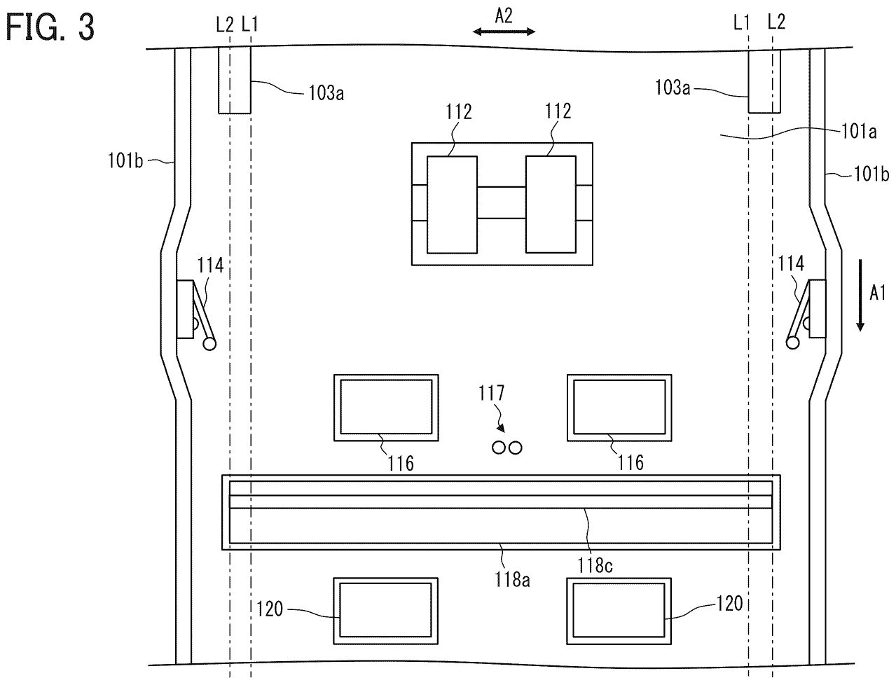

FIG. 3 schematically illustrates the second sensor 114 and the third sensor 117. FIG. 3 is a schematic view of the lower housing 101 when viewed from above with the upper housing 102 opened.

The second sensor 114 is an example of a first media sensor and detects a medium conveyed to the position of the second sensor 114. In the example illustrated in FIG. 3, the media conveying apparatus 100 includes two second sensors 114 arranged side by side with a space therebetween in the width direction A2. The second sensor 114 is located downstream from the feed roller 112 in the media conveyance direction A1. In the example illustrated in FIG. 3, the second sensor 114 is located upstream from the second conveyance roller 116 (i.e., the first conveyance roller 115). The skew (slanting) of media generally starts to occur near the feed roller 112 and the separation roller 113, which are a unit for separating media. Since the second sensor 114 is located upstream from the first conveyance roller 115, the media conveying apparatus 100 can detect the skew of media at an earlier stage. The second sensor 114 may be located downstream from the first conveyance roller 115 and upstream from the imaging device 118. Alternatively, the second sensor 114 may be located downstream from the imaging device 118.

Further, the second sensor 114 is located inside of a side wall 101b of the media conveyance path (i.e., the center side of the media conveyance path) in the width direction A2 perpendicular to the media conveyance direction A1. The second sensor 114 is located outside of a maximum size media supported by the media conveying apparatus 100 placed on the media tray 103 in the width direction A2 perpendicular to the media conveyance direction A1 (or the side wall 101b side). In other words, the second sensor 114 is located outside of the position L1 of an inner side face of the side guide 103a positioned at the outermost position in the width direction A2. Accordingly, the second sensor 114 is located on the media conveyance path in an area that is outside of an area through which the media passes when conveyed normally. This configuration allows the media conveying apparatus 100 to accurately predict whether a medium being conveyed will collide with the side wall 101b by using the second sensor 114.

Each end of the imaging sensors 118c and 118d of the imaging device 118 is located outside of the maximum size media supported by the media conveying apparatus 100 placed on the media tray 103 in the width direction A2 perpendicular to the media conveyance direction A1. The second sensor 114 is located outside of an end position L2 of the imaging sensors 118c and 118d of the imaging device 118 in the width direction A2 perpendicular to the media conveyance direction A1. Accordingly, the second sensor 114 is located at a position closer to the side wall 101b. This configuration allows the media conveying apparatus 100 to more accurately predict whether a medium being conveyed will collide with the side wall 101b by using the second sensor 114. The second sensor 114 may be located at the end position L2 of the imaging sensors 118c and 118d of the imaging device 118 in the width direction A2. This configuration allows the media conveying apparatus 100 to accurately detect that a medium is passing beyond the imaging range of the imaging device 118 and a portion of the medium is not included in the input image by using the second sensor 114. The second sensor 114 may be located inside of the end position L2 of the imaging sensors 118c and 118d of the imaging device 118 in the width direction A2.

The second sensor 114 is for example a micro switch and includes an actuator, a button, and an electric circuit. The actuator is located to be swingable between an initial position where the button is not pressed and a pressing position where the button is pressed. The actuator is located at the initial position when the actuator is not in contact with a medium being conveyed. When pressed outside by the medium being conveyed, the actuator is moved to the pressing position and presses the button. The button is arranged to open the electric circuit open and prevent current from flowing through the electric circuit while the button is not pressed by the actuator and to close the electric circuit and allow current to flow through the electric circuit while the button is pressed by the actuator. The second sensor 114 generates and outputs a second detection signal. The second detection signal has a signal value that changes between a state in which current flows through the electric circuit and a state in which no current flows through the electric circuit. In other words, the signal value of the second detection signal changes between a state in which a medium is present at the position of the second sensor 114 and a state in which no medium is present at the position of the second sensor 114. In other words, the second detection signal indicates whether a medium is present at the position of the second sensor 114, thus a detection result of the medium by the second sensor 114.

The second sensor 114 may be any other sensor that can detect the presence or absence of a medium. For example, the second sensor 114 includes a light emitter, a light receiver, and a light guide. The light emitter and the light receiver are located on one side of the media conveyance path. The light guide faces the light emitter and the light receiver across the media conveyance path. The light emitter is for example a light emitting diode (LED) and emits light toward the media conveyance path. The light receiver is, for example, a photodiode and receives light emitted from the light emitter and guided by the light guide. When a medium is present at a position facing the second sensor 114, the light emitted from the light emitter is blocked by the medium and is not detected by the light receiver. Based on the intensity of the light received by the light receiver, the second sensor 114 generates and outputs a second detection signal whose signal value changes depending on whether a medium is present at the position of the second sensor 114. In one embodiment, the second sensor 114 includes a reflector, such as a mirror, in place of the light guide. In another embodiment, the light emitter and the light receiver are located facing each other with the media conveyance path therebetween.

In another embodiment, the second sensor 114 includes an actuator, a light emitter, and a light receiver and determines whether light emitted from the light emitter is blocked by the actuator. The number of the second sensor 114 is not limited two, but may be one.

The third sensor 117 is an example of a second media sensor and detects a medium conveyed to the position of the third sensor 117. The third sensor 117 is located downstream from the second sensor 114 in the media conveyance direction A1. In the example illustrated in FIG. 3, the third sensor 117 is located downstream from the second conveyance roller 116 (i.e., the first conveyance roller 115) and upstream from the imaging device 118. The third sensor 117 may be located upstream from the first conveyance roller 115 or may be located downstream from the imaging device 118. Further, the third sensor 117 is located inside of the second sensor 114 (i.e., the center side of the media conveyance path) in the width direction A2 perpendicular to the media conveyance direction A1. In the example illustrated in FIG. 3, the third sensor 117 is located between two feed rollers 112 in the width direction A2.

In one example, the third sensor 117 includes a light emitter and a light receiver located on one side of the media conveyance path. The third sensor 117 further includes a light guide facing the light emitter and the light receiver with the media conveyance path therebetween. The light emitter is, for example, an LED and emits light toward the media conveyance path. The light receiver is, for example, a photodiode and receives light emitted from the light emitter and guided by the light guide. Based on the intensity of the light received by the light receiver, the third sensor 117 generates and outputs a third detection signal whose signal value changes depending on whether a medium is present at the position of the third sensor 117. In other words, the third detection signal indicates whether a medium is present at the position of the third sensor 117, thus a detection result of the medium by the third sensor 117. A reflector such as a mirror may be used instead of the light guide. The light emitter and the light receiver may face each other across the media conveyance path. The third sensor 117 may detect the presence of a medium with for example a contact sensor that allows a certain current to flow when a medium is in contact with the contact sensor or when no medium is in contact with the contact sensor.

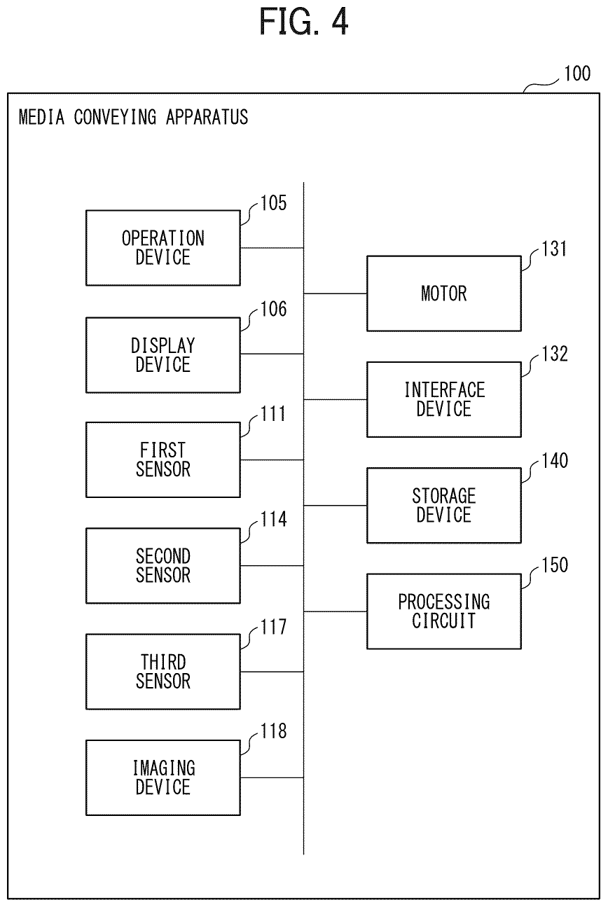

FIG. 4 is a block diagram schematically illustrating a configuration of the media conveying apparatus 100.

The media conveying apparatus 100 further includes a motor 131, an interface device 132, a storage device 140, and a processing circuit 150 in addition to the configuration described above.

The motor 131 includes one or more motors. In response to a control signal from the processing circuit 150, the motor 131 rotates the feed roller 112, the separation roller 113, the first conveyance roller 115, the second conveyance roller 116, the first ejection roller 119, and the second ejection roller 120 to convey media. One of the first conveyance roller 115 and the second conveyance roller 116 may be a driven roller driven to rotate by the other roller. One of the first ejection roller 119 and the second ejection roller 120 may be a driven roller driven to rotate by the other roller.

The interface device 132 includes an interface circuit compatible with a serial bus such as a universal serial bus (USB). The interface device 132 is electrically connected to an information processing apparatus such as a personal computer or a mobile information terminal to transmit and receive an input image and various kinds of information to and from the information processing apparatus. The interface device 132 may be substituted by a communication unit including an antenna to transmit and receive radio signals and a wireless communication interface device to transmit and receive the signals through a wireless communication line according to a predetermined communication protocol. The predetermined communication protocol is, for example, a wireless local area network (LAN) communication protocol. The communication unit may include a wired communication interface device to transmit and receive a signal via a wired communication line in accordance with a communication protocol such as a wired LAN communication protocol.

The storage device 140 includes memories such as a random-access memory (RAM) and a read-only memory (ROM), a fixed disk device such as a hard disk, or a portable memory such as a flexible disk or an optical disc. The storage device 140 stores for example computer programs, databases, and tables used for various processes performed by the media conveying apparatus 100. The computer programs may be installed into the storage device 140 from a computer-readable portable recording medium using for example a known setup program. Examples of the portable recording medium include a compact disc read-only memory (CD-ROM) and a digital versatile disc read-only memory (DVD-ROM).

The processing circuit 150 operates in accordance with a program stored in the storage device 140 in advance. The processing circuit 150 is, for example, a central processing unit (CPU). Alternatively, a digital signal processor (DSP), a large-scale integration (LSI), an application-specific integrated circuit (ASIC), a field-programmable gate array (FPGA), etc. may be used as the processing circuit 150.

The processing circuit 150 is connected to the operation device 105, the display device 106, the first sensor 111, the second sensor 114, the third sensor 117, the imaging device 118, the motor 131, the interface device 132, the storage device 140, etc., and controls these components. The processing circuit 150 controls the driving of the motor 131, the imaging of the imaging device 118, etc. to acquire an input image from the imaging device 118, and transmits the input image to the information processing apparatus via the interface device 132. Further, the processing circuit 150 determines whether a media jam occurs based on the second detection signal received from the second sensor 114 and the third detection signal received from the third sensor 117. When the processing circuit 150 determines that a media jam occurs, the processing circuit 150 performs error handling.

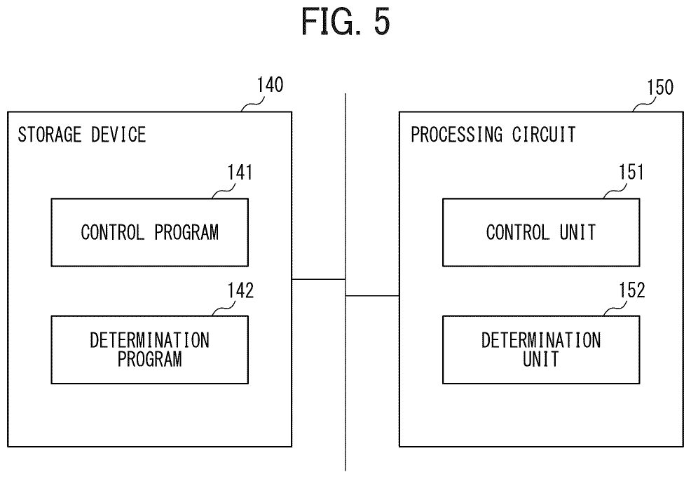

FIG. 5 is a block diagram schematically illustrating an example configuration of the storage device 140 and the processing circuit 150.

As illustrated in FIG. 5, the storage device 140 stores a control program 141, a determination program 142, etc. The control program 141 and the determination program 142 are functional modules implemented by software operating on a processor. The processing circuit 150 reads each of the control program 141 and the determination program 142 from the storage device 140 and operates in accordance with the read program. Thus, the processing circuit 150 functions as a control unit 151 and a determination unit 152.

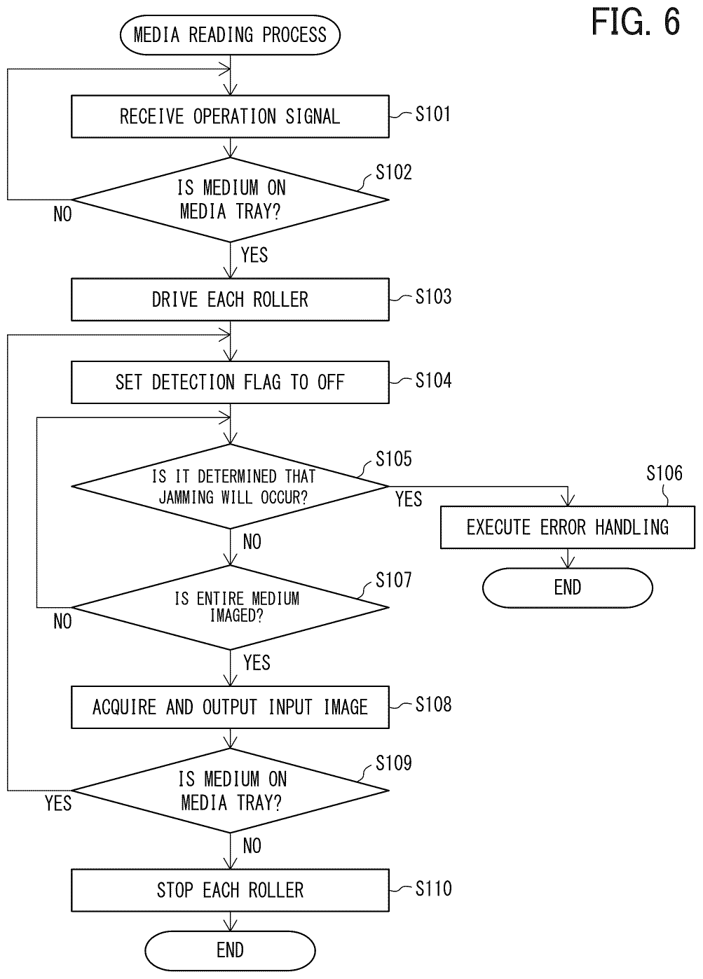

FIG. 6 is a flowchart illustrating example operations of a media reading process performed by the media conveying apparatus 100.

Example operations of the media reading process performed by the media conveying apparatus 100 will be described below with reference to the flowchart illustrated in FIG. 6. The series of operations described below is executed by the processing circuit 150 etc. in cooperation with the components of the media conveying apparatus 100 in accordance with the program stored in the storage device 140 in advance.

The control unit 151 waits until the control unit 151 receives an operation signal instructing the reading of media from the operation device 105 or the interface device 132 (step S101). The operation signal is output when the user inputs an instruction to read media using the operation device 105 or the information processing apparatus.

Then, in response to receipt of the operation signal, the control unit 151 acquires a first detection signal from the first sensor 111 and determines whether a medium is placed on the media tray 103 based on the acquired first detection signal (step S102). When no media are placed on the media tray 103, the control unit 151 ends the series of steps.

By contrast, when a medium is placed on the media tray 103, the control unit 151 controls the feed roller 112, the separation roller 113, the first conveyance roller 115, the second conveyance roller 116, the first ejection roller 119, and/or the second ejection roller 120 to rotate (step S103). The control unit 151 drives the motor 131 to rotate the rollers to feed and convey the medium.

Then, the control unit 151 sets a detection flag to off (step S104). The detection flag is set to off when the feeding of the medium is started, and is set to on when the third sensor 117 detects the medium. In other words, when the leading end of the medium passes the position of the third sensor 117, the detection flag is set to on.

Then, the control unit 151 determines whether the determination unit 152 determines (predicts) that jamming of the medium occurs in a jam determination process (step S105). The jam determination process is executed in parallel with the media reading process. In the jam determination process, the determination unit 152 determines (predicts) whether jamming of the medium occurs based on the detection result of the medium by the second sensor 114 and the detection result of the medium by the third sensor 117. The details of the jam determination process will be described below.

When the determination unit 152 determines that jamming of the medium occurs in the jam determination process, the control unit 151 executes error handling (step S106) and then ends the series of steps. The control unit 151 executes the error handling by stopping the motor 131 to stop the feeding and conveyance of the medium. As a result, the media conveying apparatus 100 can prevent jamming of the medium and prevent the medium from being damaged. The control unit 151 may execute the error handling by controlling the display device 106 to display information indicating that jamming of the medium is likely to occur or transmitting the information to the information processing apparatus via the interface device 132 to notify the user of possible jamming of the medium. Upon recognizing that jamming of the medium is likely to occur, the user can place the medium on the media tray 103 again in appropriate position to ensure that the medium is not skewed when re-conveyed. Accordingly, the media conveying apparatus 100 can prevent or reduce jamming of the medium.

By contrast, when the determination unit 152 does not determine that jamming of the medium occurs in the jam determination process in step S105, the control unit 151 determines whether the entire medium is imaged (step S107). For example, the control unit 151 determines whether the trailing end of the medium has passed the position of the third sensor 117 based on the third detection signal received from the third sensor 117. The control unit 151 periodically acquires a third detection signal from the third sensor 117. When the signal value of the third detection signal changes from a value indicating the presence of the medium to a value indicating the absence of the medium, the control unit 151 determines that the trailing end of the medium has passed the position of the third sensor 117. When a predetermined time has elapsed since the trailing end of the medium passed the position of the third sensor 117, the control unit 151 determines that the trailing end of the medium has passed the imaging position of the imaging device 118 and the entire medium is imaged. Alternatively, when a predetermined time has elapsed since the feeding of a medium was started, the control unit 151 may determine that the entire medium being conveyed is obtained.

When the entire medium being conveyed is not imaged, the control unit 151 returns the process to step S105 and repeats the processing of steps S105 to S107.

By contrast, when the entire medium being conveyed is imaged, the control unit 151 acquires an input image from the imaging device 118 and transmits the acquired input image to the information processing apparatus via the interface device 132 to output the input image (step S108).

Then, the control unit 151 determines whether a medium remains on the media tray 103 based on the first detection signal received from the first sensor 111 (step S109). When a medium remains on the media tray 103, the control unit 151 returns the process to step S104 and repeats the processing of steps S104 to S109.

By contrast, when no medium remains on the media tray 103, the control unit 151 controls the feed roller 112, the separation roller 113, the first conveyance roller 115, the second conveyance roller 116, the first ejection roller 119, and/or the second ejection roller 120 to stop rotating (step S110). The control unit 151 controls the motor 131 to stop the rotation of each roller, and ends the series of steps.

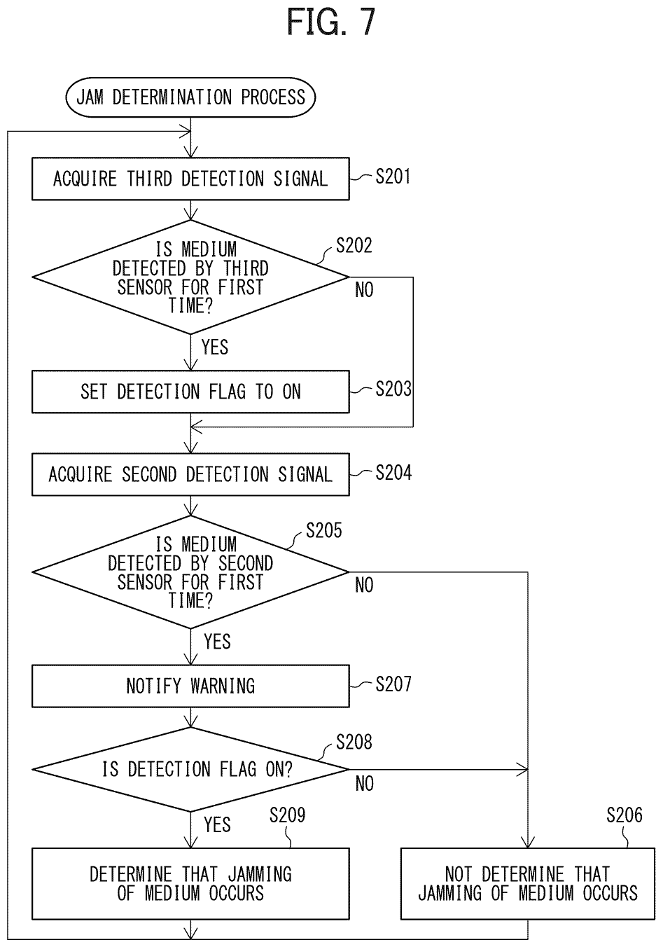

FIG. 7 is a flowchart illustrating example operations of the jam determination process performed by the media conveying apparatus 100.

Example operations of the jam determination process performed by the media conveying apparatus 100 will be described hereinafter with reference to the flowchart illustrated in FIG. 7. The series of operations described hereinafter is executed by, for example, the processing circuit 150 in cooperation with the components of the media conveying apparatus 100 in accordance with the program stored in the storage device 140 in advance. The series of operations illustrated in FIG. 7 is executed during conveyance of a medium.

First, the determination unit 152 acquires a third detection signal from the third sensor 117 (step S201).

Then, the determination unit 152 determines whether the third sensor 117 has detected the medium for the first time based on the acquired third detection signal (step S202). When the signal value of the previously acquired third detection signal indicates the absence of the medium and the signal value of the currently acquired third detection signal indicates the presence of the medium, the determination unit 152 determines that the third sensor 117 has detected the medium for the first time. When the third sensor 117 detects no medium or when the third sensor 117 has already detected the medium, the determination unit 152 does not perform any processing, and the process proceeds to step S204.

By contrast, when the third sensor 117 has detected the medium for the first time, the determination unit 152 sets the detection flag to on (step S203).

Then, the determination unit 152 acquires a second detection signal from the second sensor 114 (step S204).

Then, the determination unit 152 determines whether the second sensor 114 has detected the medium for the first time based on the acquired second detection signal (step S205). When the signal value of the previously acquired second detection signal indicates the absence of the medium and the signal value of the currently acquired second detection signal indicates the presence of the medium, the determination unit 152 determines that the second sensor 114 has detected the medium for the first time. In a case where the media conveying apparatus 100 includes two second sensors 114, the determination unit 152 determines whether the second sensor 114 has detected the medium for the first time for each of the two second sensors 114.

Alternatively, the determination unit 152 may determine that the second sensor 114 has detected the medium for the first time when the signal value of the second detection signal changes from a value indicating the absence of the medium to a value indicating the presence of the medium and thereafter does not change continuously for a predetermined number of times or a predetermined amount of time (e.g., 1 second). Accordingly, the determination unit 152 can determine that the second sensor 114 has not detected a medium when the medium comes into slight contact with the second sensor 114. As a result, the erroneous prediction of jamming of the medium can be prevented.

When none of the second sensors 114 detects the medium or when each of the second sensors 114 has already detected the medium, the determination unit 152 does not determine that the skew causing the jamming of the medium occurs. In this case, the determination unit 152 does not determine (predict) that jamming of the medium occurs (step S206), and returns the process to step S201.

By contrast, when any of the second sensors 114 has detected the medium for the first time, the determination unit 152 notifies the user of a warning (step S207). The determination unit 152 notifies the user of a warning by displaying information indicating that the medium has passed beyond the imaging range of the imaging device 118 and that part of the medium is not likely to be included in the input image on the display device 106 or by transmitting the information to the information processing apparatus via the interface device 132.

Then, the determination unit 152 determines whether the detection flag is on (step S208).

When the detection flag is off, the determination unit 152 does not determine that the skew causing the jamming of the medium occurs. In this case, the determination unit 152 does not determine (predict) that jamming of the medium occurs (step S206), and returns the process to step S201. In other words, when the medium is detected by the second sensor 114 before the medium is detected by the third sensor 117, the determination unit 152 does not determine that jamming of the medium occurs.

By contrast, when the detection flag is on, the determination unit 152 determines that the skew causing the jamming of the medium occurs. In this case, the determination unit 152 determines (predicts) that jamming of the medium occurs (step S209), and returns the process to step S201. In other words, when the medium is detected by the second sensor 114 after the medium is detected by the third sensor 117, the determination unit 152 determines that jamming of the medium occurs. In this case, the control unit 151 determines in step S105 in FIG. 6 that the determination unit 152 predicts that jamming of the medium occurs, and executes error handling in step S106.

As described above, the determination unit 152 determines whether jamming of a medium occurs based on the detection result of the medium by the second sensor 114 and the detection result of the medium by the third sensor 117.

The following describes the technical meaning of determining whether jamming of a medium occurs based on the detection result of the medium by the second sensor 114 and the detection result of the medium by the third sensor 117.

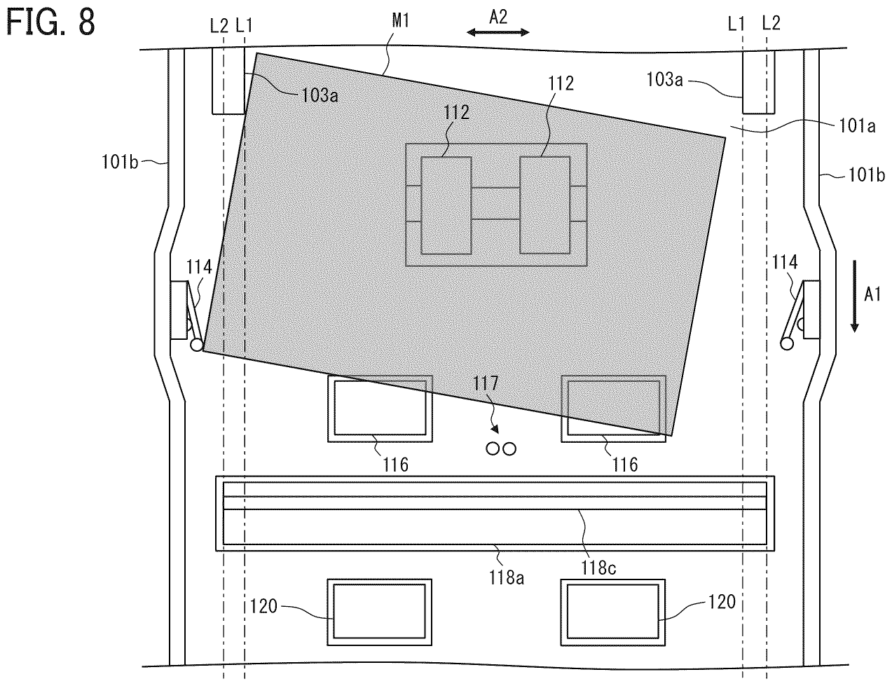

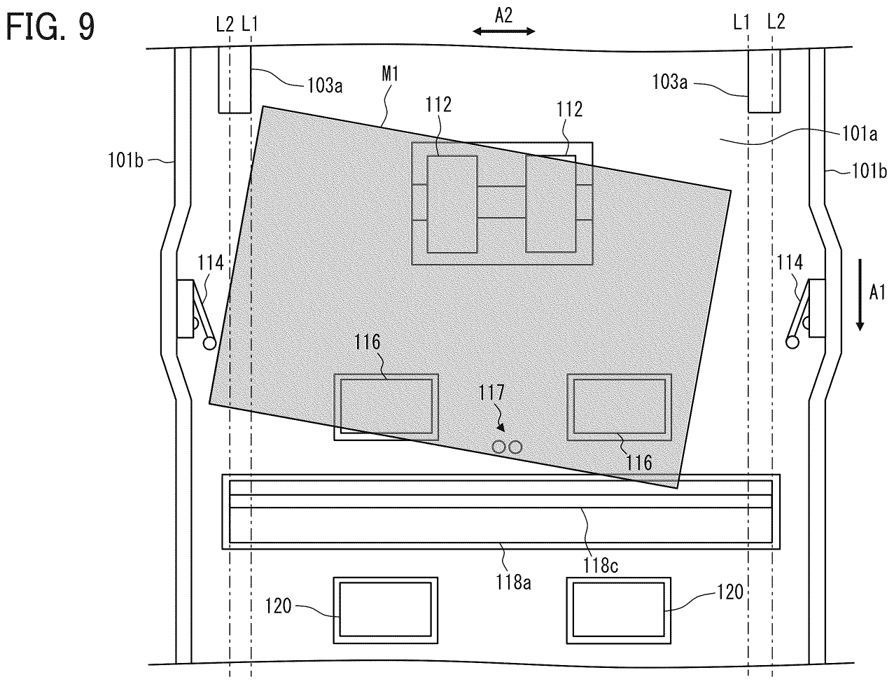

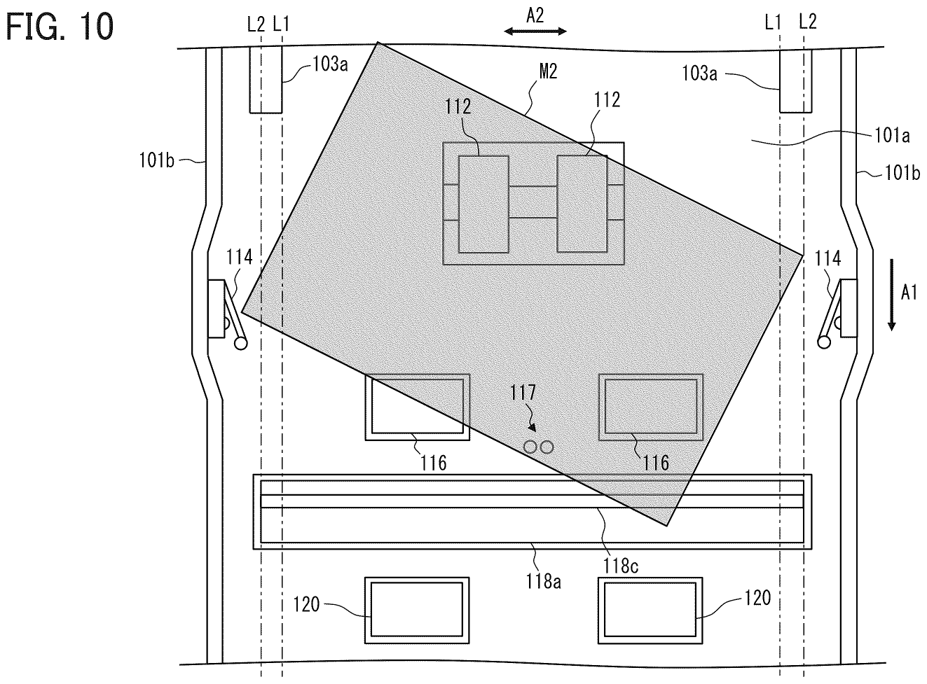

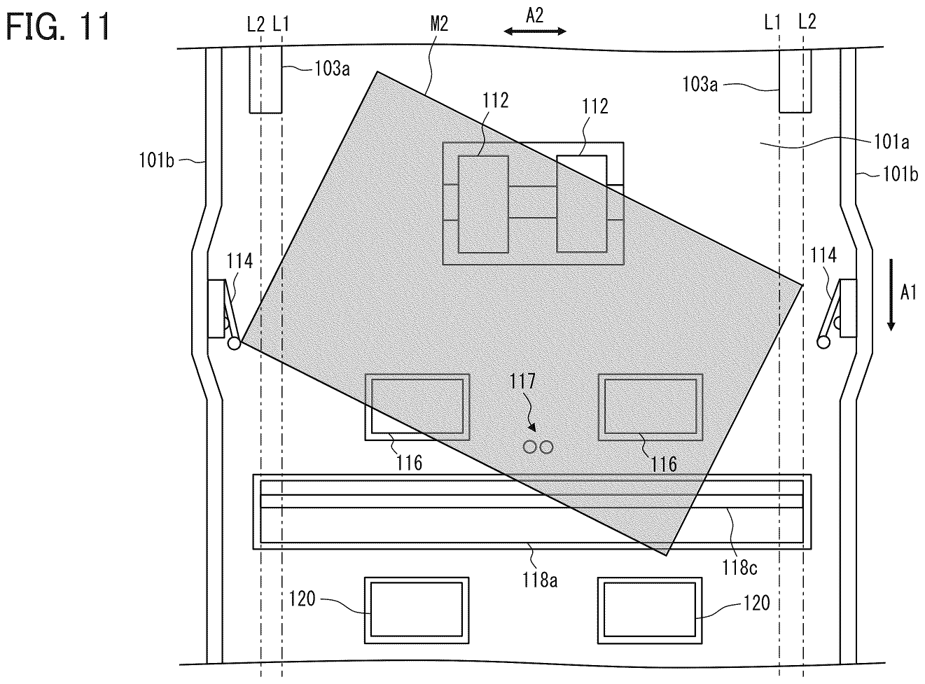

FIG. 8, FIG. 9, FIG. 10, and FIG. 11 schematically illustrate a medium conveyed and passing the position of the second sensor 114 in a skewed orientation. FIG. 8, FIG. 9, FIG. 10, and FIG. 11 are schematic views of the lower housing 101 when viewed from above with the upper housing 102 opened. FIG. 8 and FIG. 9 illustrate a medium M1 that is slightly skewed. FIG. 10 and FIG. 11 illustrate a medium M2 that is greatly skewed.

As illustrated in FIG. 8, the leading end of the medium M1 passes the position of the second sensor 114. Subsequently, as illustrated in FIG. 9, the leading end of the medium M1 passes the position of the third sensor 117. In this situation, the medium M1 is conveyed in a skewed orientation with the skew of the medium M1 being likely to be sufficiently small. In this case, the medium M1 is likely to be ejected without coming into contact with the side wall 101b. In a case where a medium is detected by the second sensor 114 before the medium is detected by the third sensor 117, the media conveying apparatus 100 does not predict that jamming of the medium occurs, and continues the conveyance of the medium to eject the medium. Accordingly, the user does not have to open the upper housing 102 to remove the medium. As a result, the media conveying apparatus 100 can enhance user convenience.

In contrast, as illustrated in FIG. 10, the leading end of the medium M2 passes the position of the third sensor 117, and subsequently, as illustrated in FIG. 11, the leading end of the medium M2 passes the position of the second sensor 114. In this situation, the medium M2 is likely to be greatly skewed when conveyed. In this case, the medium M1 is likely to collide with the side wall 101b, and a media jam is likely to occur. In a case where a medium is detected by the second sensor 114 after the medium is detected by the third sensor 117, the media conveying apparatus 100 predicts that jamming of the medium occurs, and stops the conveyance of the medium. Accordingly, the media conveying apparatus 100 can prevent jamming of a medium and prevent the medium from being damaged.

As described above, the media conveying apparatus 100 can more accurately predict whether jamming of a medium occurs by using both the detection result of the medium by the second sensor 114 and the detection result of the medium by the third sensor 117.

As described in detail above, the media conveying apparatus 100 predicts jamming of a medium based on the detection result of the medium by the second sensor 114, which is located outside of the maximum size media supported by the media conveying apparatus 100 placed on the media tray in a direction perpendicular to the media conveyance direction, and the detection result of the medium by the third sensor 117, which is located downstream from the second sensor 114. This configuration allows the media conveying apparatus 100 to more accurately determine whether jamming of the medium occurs.

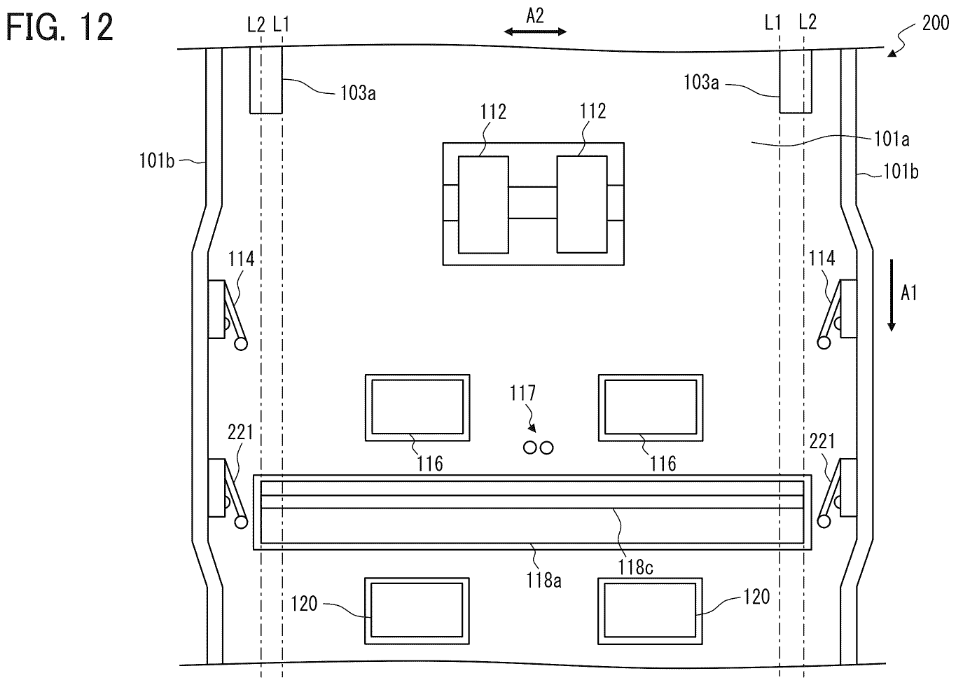

FIG. 12 schematically illustrates a fourth sensor 221 of a media conveying apparatus 200 according to another embodiment. FIG. 12 is a schematic view of the lower housing 101 of the media conveying apparatus 200 when viewed from above with the upper housing 102 opened.

As illustrated in FIG. 12, the media conveying apparatus 200 includes the components of the media conveying apparatus 100, and further includes the fourth sensor 221.

In this embodiment, the fourth sensor 221 is an example of a second media sensor and detects a medium conveyed to the arrangement position of the fourth sensor 221. In the example illustrated in FIG. 12, the media conveying apparatus 200 includes two fourth sensors 221 arranged side by side with a space therebetween in the width direction A2. The fourth sensor 221 is located downstream from the second sensor 114 in the media conveyance direction A1. In the example illustrated in FIG. 12, the fourth sensor 221 is located downstream from the second conveyance roller 116 (i.e., the first conveyance roller 115) such that the fourth sensor 221 overlaps the imaging device 118 when viewed in the width direction A2. This configuration allows the media conveying apparatus 200 to accurately detect that a medium passes beyond the imaging range of the imaging device 118 and a portion of the medium is not included in the input image by using the fourth sensor 221. The fourth sensor 221 may be located upstream from the first conveyance roller 115. Alternatively, the fourth sensor 221 may be located downstream from the first conveyance roller 115 and upstream from the imaging device 118. Still alternatively, the fourth sensor 221 may be located downstream from the imaging device 118.

Further, the fourth sensor 221 is located at a position that is the same as the position of the second sensor 114 in the width direction A2 perpendicular to the media conveyance direction A1. The phrase “position that is the same as the position of the second sensor 114” or “the same position as the position of the second sensor 114” is not limited to a position that is exactly the same as the arrangement position of the second sensor 114 and includes a position in an area within a predetermined range (e.g., within 30 mm) from the arrangement position of the second sensor 114.

The fourth sensor 221 is located inside of the side wall 101b of the media conveyance path (i.e., the center side of the media conveyance path) in the width direction A2 perpendicular to the media conveyance direction A1. The fourth sensor 221 is located outside of a maximum size media supported by the media conveying apparatus 200 placed on the media tray (or the side wall 101b side) in the width direction A2 perpendicular to the media conveyance direction A1. In other words, the fourth sensor 221 is located outside of the position L1 of inner side face of the side guide 103a positioned at the outermost position in the width direction A2. Accordingly, the fourth sensor 221 is located outside an area where media are conveyed along the media conveyance path under normal operating conditions. This configuration allows the media conveying apparatus 200 to accurately predict using the fourth sensor 221 whether a medium being conveyed will collide with the side wall 101b.

Further, the fourth sensor 221 is located outside of the end position L2 of the imaging sensors 118c and 118d of the imaging device 118 in the width direction A2 perpendicular to the media conveyance direction A1. Accordingly, the fourth sensor 221 is located at a position closer to the side wall 101b. This configuration allows the media conveying apparatus 200 to predict more accurately using the fourth sensor 221 whether a medium being conveyed will collide with the side wall 101b. The fourth sensor 221 may be located at the end position L2 of the imaging sensors 118c and 118d of the imaging device 118 in the width direction A2. This configuration allows the media conveying apparatus 200 to accurately detect that a medium passes beyond the imaging range of the imaging device 118 and a portion of the medium not being included in the input image generated. Alternatively, the fourth sensor 221 may be located inside of the end position L2 of the imaging sensors 118c and 118d of the imaging device 118 in the width direction A2.

The fourth sensor 221 has a structure similar to that of the second sensor 114. The fourth sensor 221 is for example a micro switch and includes an actuator, a button, and an electric circuit. The fourth sensor 221 generates and outputs a fourth detection signal. The fourth detection signal has a signal value that changes between a state in which current flows through the electric circuit and a state in which no current flows through the electric circuit. In other words, the signal value of the fourth detection signal changes between a state in which a medium is present at the position of the fourth sensor 221 and a state in which no medium is present at the position of the fourth sensor 221. In other words, the fourth detection signal indicates whether a medium is present at the position of the fourth sensor 221, thus a detection result of the medium by the fourth sensor 221.

The fourth sensor 221 may be any other sensor such as an optical detection sensor that can detect the presence or absence of a medium. The number of the fourth sensor 221 is not limited to one, and may be two or more.

Like the media conveying apparatus 100, the media conveying apparatus 200 executes the media reading process illustrated in FIG. 6. In a case where the media conveying apparatus 200 includes two second sensors 114, the media conveying apparatus 200 manages a detection flag for each of the two second sensors 114. In this case, in step S104, the control unit 151 sets the respective detection flags corresponding to the two second sensors 114 to off.

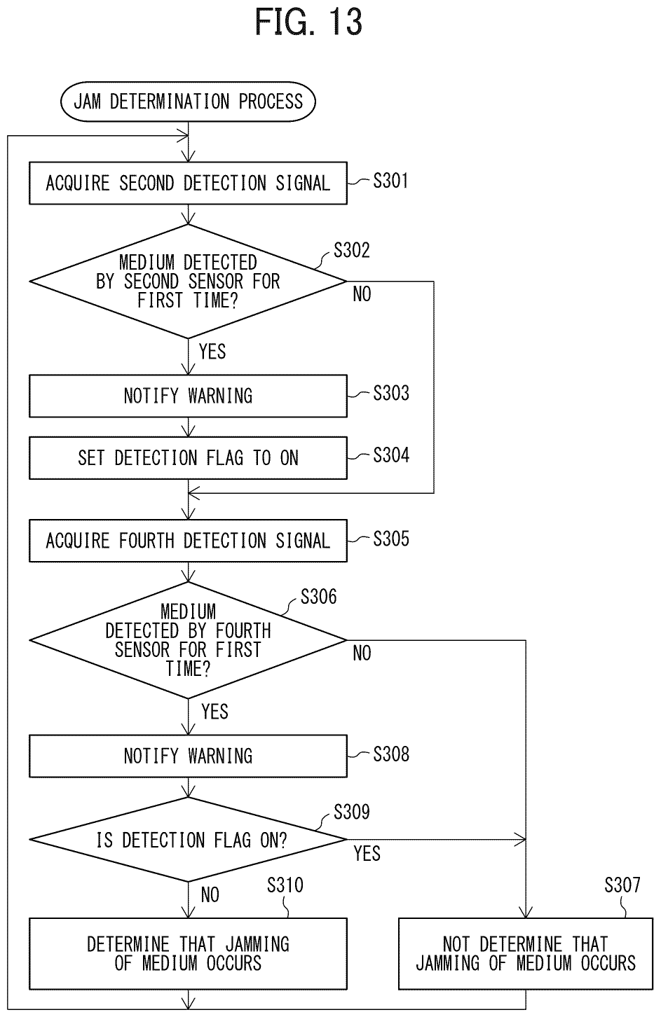

FIG. 13 is a flowchart illustrating example operations of a jam determination process performed by the media conveying apparatus 200.

Example operations of the jam determination process performed by the media conveying apparatus 200 will be described hereinafter with reference to the flowchart illustrated in FIG. 13. The series of operations described hereinafter is executed by, for example, the processing circuit 150 in cooperation with the components of the media conveying apparatus 200 in accordance with the program stored in the storage device 140 in advance. The series of operations illustrated in FIG. 13 is executed, instead of the flowchart illustrated in FIG. 7, during conveyance of a medium.

First, the determination unit 152 acquires second detection signals from the second sensors 114 (step S301).

Then, the determination unit 152 determines, whether the second sensors 114 have detected the medium for the first time based on acquired second detection signals in the same or substantially the same manner as step S205 of FIG. 7 (step S302). When none of the second sensors 114 detects the medium or when each of the second sensors 114 has already detected the medium, the determination unit 152 does not perform processing, and the process proceeds to step S305.

By contrast, when any of the second sensors 114 has detected the medium for the first time the determination unit 152 notifies the user of a warning in the same or substantially the same manner as step S207 of FIG. 7 (step S303).

Then, the determination unit 152 sets the detection flag corresponding to the second sensor 114 that has detected the medium for the first time to on (step S304).

Then, the determination unit 152 acquires a fourth detection signal from the fourth sensor 221 (step S305).

Then, the determination unit 152 determines whether the fourth sensor 221 has detected the medium for the first time based on the acquired fourth detection signal (step S306). When the signal value of the previously acquired fourth detection signal indicates the absence of the medium and the signal value of the currently acquired fourth detection signal indicates the presence of the medium, the determination unit 152 determines that the fourth sensor 221 has detected the medium for the first time. In a case where the media conveying apparatus 200 includes two fourth sensors 221, the determination unit 152 determines for each of the two fourth sensors 221 whether the fourth sensor 221 has detected the medium for the first time.

Alternatively, the determination unit 152 may determine that the fourth sensor 221 has detected the medium for the first time when the signal value of the fourth detection signal changes from a value indicating the absence of the medium to a value indicating the presence of the medium and thereafter does not change continuously a predetermined number of times or continuously for a predetermined amount of time (e.g., 1 second). Accordingly, the determination unit 152 can determine that the fourth sensor 221 has not detected a medium when the medium comes into slight contact with the fourth sensor 221. As a result, the erroneous prediction of jamming of the medium can be prevented.

When none of the fourth sensors 221 detects the medium or when each of the fourth sensors 221 has already detected the medium, the determination unit 152 does not determine that the skew causing the jamming of the medium occurs. In this case, the determination unit 152 does not determine (predict) that jamming of the medium occurs (step S307), and returns the process to step S301.

By contrast, when any of the fourth sensors 221 has detected the medium for the first time the determination unit 152 notifies the user of a warning in the same or substantially the same manner as step S303 (step S308). When the user has already been notified of the warning in step S303, the processing of step S308 may be omitted.

Then, the determination unit 152 determines whether the detection flag corresponding to the second sensor 114 located at the same position as the position of the fourth sensor 221, which has detected the medium for the first time, in the width direction A2 is on (step S309).

When the detection flag is on, the determination unit 152 does not determine that the skew causing the jamming of the medium occurs. In this case, the determination unit 152 does not determine (predict) that jamming of the medium occurs (step S307), and returns the process to step S301. In other words, when the medium is detected by the fourth sensor 221 after the medium is detected by the second sensor 114, the determination unit 152 does not determine that jamming of the medium occurs.

By contrast, when the detection flag is off, the determination unit 152 determines that the skew casing the jamming of the medium occurs. In this case, the determination unit 152 determines (predicts) that jamming of the medium occurs (step S310), and returns the process to step S301. In other words, when the medium is not detected by the second sensor 114 and is detected by the fourth sensor 221, the determination unit 152 determines that jamming of the medium occurs. In this case, the control unit 151 determines in step S105 in FIG. 6 that the determination unit 152 predicts that jamming of the medium occurs, and executes error handling in step S106.

As described above, the determination unit 152 determines whether jamming of a medium occurs based on the detection result of the medium by the second sensor 114 and the detection result of the medium by the fourth sensor 221.

The following describes the technical meaning of determining whether jamming of a medium occurs based on the detection result of the medium by the second sensor 114 and the detection result of the medium by the fourth sensor 221.

When a medium is skewed from the beginning of feeding and the amount of skew does not change during feeding, the leading end of the medium is likely to first pass the position of the second sensor 114 and then pass the position of the fourth sensor 221, as the medium M1 illustrated in FIG. 8. In this case, the medium is likely to be ejected without coming into contact with the side wall 101b. In a case where a medium is detected by the fourth sensor 221 after the medium is detected by the second sensor 114, the media conveying apparatus 200 does not predict that jamming of the medium occurs, and continues the conveyance of the medium to eject the medium. Accordingly, the user does not have to open the upper housing 102 to remove the medium. As a result, the media conveying apparatus 100 can enhance user convenience.

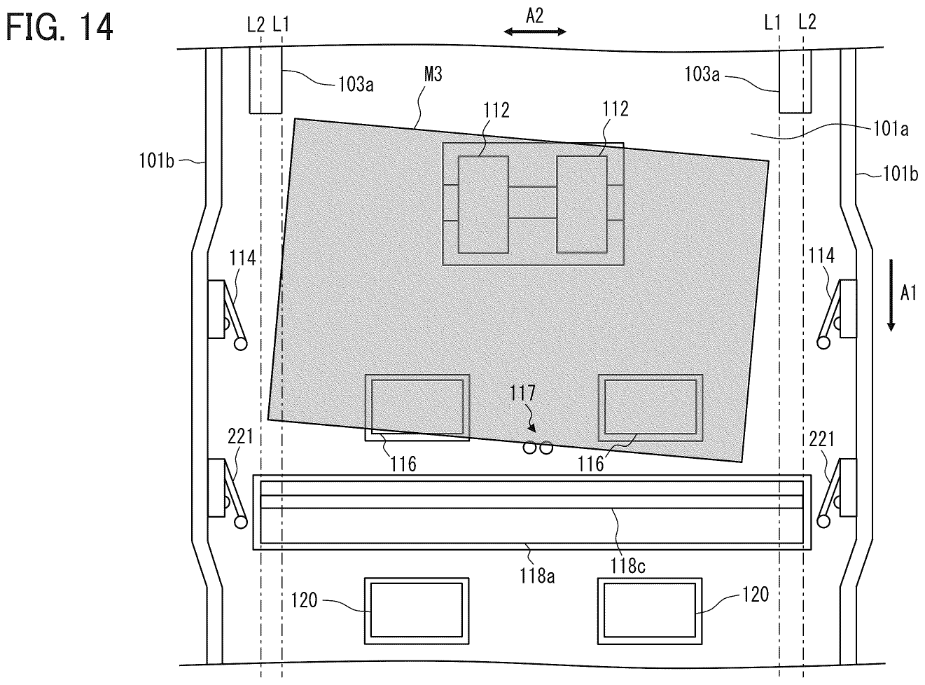

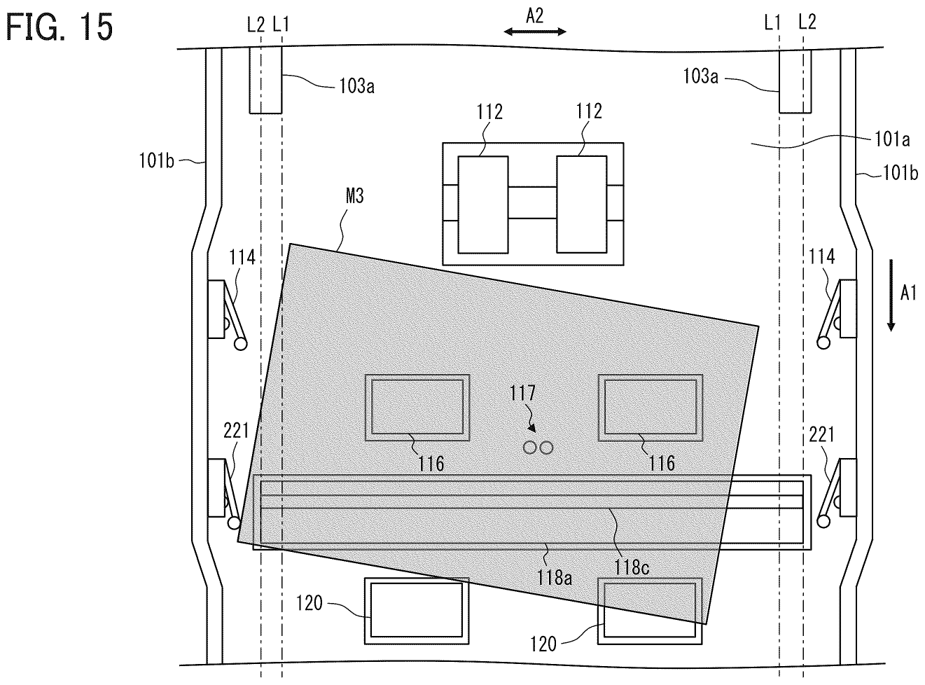

FIG. 14 and FIG. 15 schematically illustrate a medium M3 for which so-called accumulated skew occurs. Specifically, the amount of skew of the medium gradually increases as a medium being conveyed travels. FIG. 14 and FIG. 15 are schematic views of the lower housing 101 when viewed from above with the upper housing 102 opened.

As illustrated in FIG. 14 and FIG. 15, in a case where the leading end of the medium M3 passes the position of the fourth sensor 221 without passing the position of the second sensor 114, accumulated media skew is likely to have occurred. In this case, the amount of skew of the medium M3 increases as the medium M3 being conveyed, and the medium M3 may likely end up colliding with the side wall 101b and causing a media jam. In a case where a medium is not detected by the second sensor 114 and is detected by the fourth sensor 221, the media conveying apparatus 200 predicts that jamming of the medium occurs and stops the conveyance of the medium. Accordingly, the media conveying apparatus 100 can prevent jamming of a medium and prevent the medium from being damaged.

As described above, the media conveying apparatus 200 can more accurately predict whether jamming of a medium occurs by using both the detection result of the medium by the second sensor 114 and the detection result of the medium by the fourth sensor 221.

The media conveying apparatus 200 may execute the jam determination process illustrated in FIG. 13 and the jam determination process illustrated in FIG. 7. This configuration allows the media conveying apparatus 200 to further reduce the occurrence of a media jam.

As described in detail above, the media conveying apparatus 200 predicts jamming of a medium based on the detection result of the medium by the second sensor 114, which is located outside of the maximum size media supported by the media conveying apparatus 200 placed on the media tray in the direction perpendicular to the media conveyance direction, and the detection result of the medium by the fourth sensor 221, which is located downstream from the second sensor 114. This configuration allows the media conveying apparatus 200 to more accurately determine whether jamming of the medium occurs.

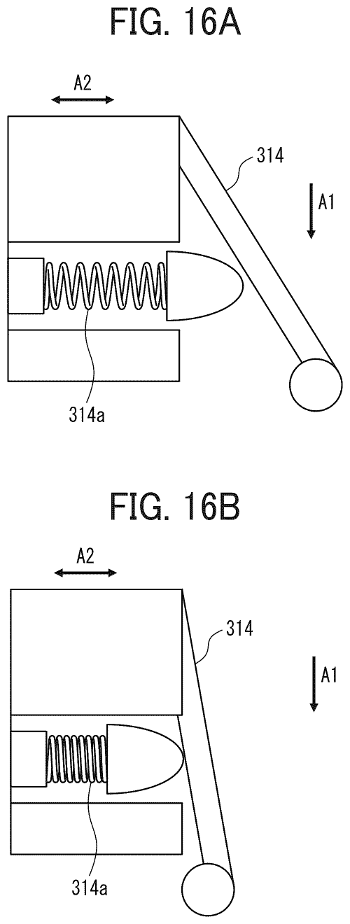

FIG. 16A and FIG. 16B are schematic views of a second sensor 314 of a media conveying apparatus according to still another embodiment.

As illustrated in FIG. 16A and FIG. 16B, the media conveying apparatus according to this embodiment includes the components of the media conveying apparatus 100 or 200 and the second sensor 314 in place of the second sensor 114.

The second sensor 314 has a configuration and functions similar to those of the second sensor 114, but includes an applying member 314a. The applying member 314a is an clastic member such as a spring. Examples of the spring include, but not limited to, a compression coil spring and a flat spring. The applying member 314a may be a rubber. The applying member 314a has an end attached to the button of the second sensor 314 and another end secured to an inner wall face of the second sensor 314 etc. to apply a force directed inward in the width direction A2 (i.e., toward the center of the media conveyance path) to the button. Accordingly, in response to a medium coming into contact with the second sensor 314, the applying member 314a applies a force directed inward in the width direction A2 perpendicular to the media conveyance direction A1 to the medium.

When a medium is conveyed in a skewed manner toward the side wall 101b and comes into contact with the second sensor 314, the second sensor 314 pushes the medium back toward the center of the media conveyance path by using the force applied by the applying member 314a. This configuration allows the media conveying apparatus to satisfactorily correct the skew of the medium.

Like the second sensor 314, the fourth sensor 221 may also include an applying member similar to the applying member 314a. This configuration allows the media conveying apparatus to correct the skew of the medium more reliably.

As described in detail above, in a case where the second sensor 314 includes the applying member 314a, the media conveying apparatus can satisfactorily correct the skew of a medium while more accurately determining whether jamming of the medium occurs.

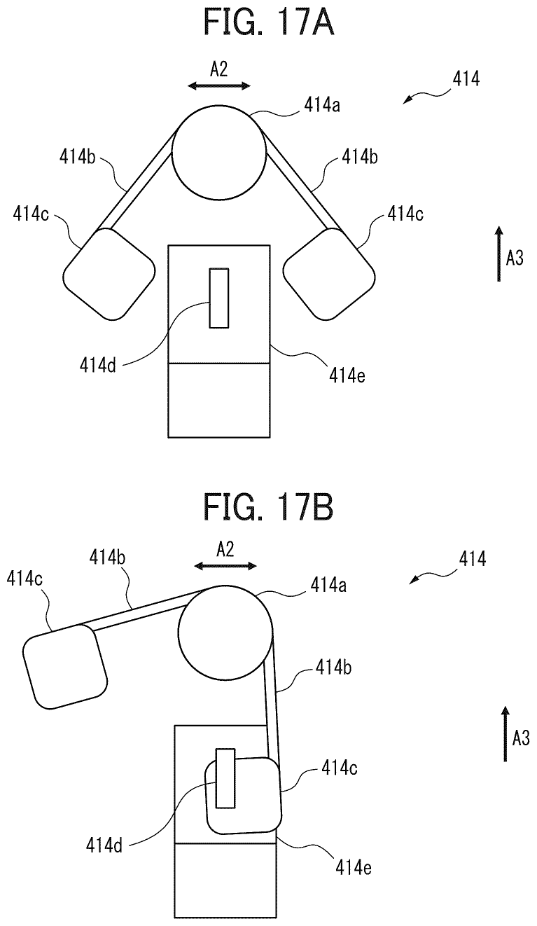

FIG. 17A and FIG. 17B are schematic views of a second sensor 414 of a media conveying apparatus according to still another embodiment.

As illustrated in FIG. 17A and FIG. 17B, the media conveying apparatus according to this embodiment includes the components of the media conveying apparatus 100 or 200 and the second sensor 414 in place of the second sensor 114.

The second sensor 414 has a pendulum structure and includes a shaft member 414a, two arm members 414b, two applying members 414c, a light emitter 414d, and a light receiver 414c. The shaft member 414a is located in an upper side and supports the arm members 414b and the applying members 414c such that the arm members 414b and the applying members 414c are swingable (or rotatable) in the width direction A2. Upper ends of the two arm members 414b are attached to the shaft member 414a such that the arm members 414b form a predetermined angle with each other. The predetermined angle is set to an angle greater than 0 degrees and less than 180 degrees (e.g., 30 degrees). The two applying members 414c are weight members having a certain weight and are attached to lower ends of the arm members 414b.

As illustrated in FIG. 17A, no medium is in contact with the arm members 414b. In this state, the arm members 414b are balanced by the applying members 414c, and the two applying members 414c are arranged at initial positions where the two applying members 414c are line-symmetric to the shaft member 414a. As illustrated in FIG. 17B, in contrast, a medium is in contact with the inner one of the arm members 414b in the width direction A2 (i.e., the arm member 414b positioned to the center side of the media conveyance path). In this state, the medium pushes the arm member 414b outward, resulting in the two applying members 414c being arranged at swing positions located outer side of the initial positions.

The light emitter 414d and the light receiver 414e are located to face each other such that one of the applying members 414c arranged at the swing positions is interposed between the light emitter 414d and the light receiver 414e. The light emitter 414d is for example an LED and emits light toward the light receiver 414e. The light receiver 414e is for example a photodiode and receives the light emitted from the light emitter 414d. When the applying member 414c is present between the light emitter 414d and the light receiver 414e, the light emitted from the light emitter 414d is blocked by the applying member 414c. Thus, the light receiver 414e does not detect the light emitted from the light emitter 414d. The second sensor 414 generates and outputs a second detection signal whose signal value changes between the presence and absence of the applying member 414c between the light emitter 414d and the light receiver 414e based on the intensity of the light received by the light receiver 414c. In other words, the second detection signal indicates whether a medium is present at the position of the second sensor 414, thus a detection result of the medium by the second sensor 414.

As described above, when a medium is in contact with the inner one of the arm members 414b in the width direction A2 (i.e., the arm member 414b positioned to the center side of the media conveyance path), the medium pushes the arm member 414b outward, resulting in the two applying members 414c being arranged at the swing positions located outer side of the initial positions. After that, the weight of the outer one of the applying members 414c returns the arm members 414b inward. In other words, in response to a medium coming into contact with the second sensor 414, the applying members 414c apply a force directed inward in the width direction A2 perpendicular to the media conveyance direction A1 to the medium.

When a medium is conveyed in a skewed manner the side wall 101b and comes into contact with the second sensor 414, the second sensor 414 pushes the medium toward the center of the media conveyance path by using the force applied by the applying members 414c. This configuration allows the media conveying apparatus to satisfactorily correct the skew of the medium.

The fourth sensor 221 may also have a pendulum structure similar to that of the second sensor 414. This configuration allows the media conveying apparatus to correct the skew of the medium more reliably.

As described in detail above, in a case where the second sensor 414 includes the applying members 414c, the media conveying apparatus can satisfactorily correct the skew of a medium while more accurately determining whether jamming of the medium occurs.

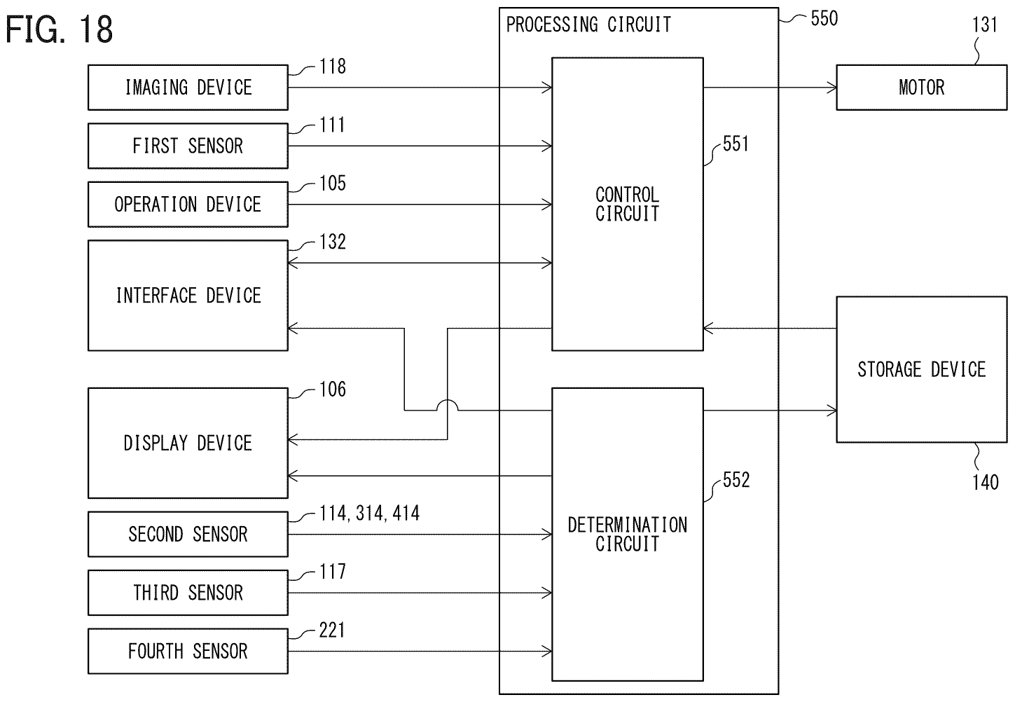

FIG. 18 is a schematic diagram illustrating an example configuration of a processing circuit 550 of a media conveying apparatus according to another embodiment. The processing circuit 550 is used in place of the processing circuit 150 of the media conveying apparatus 100. The processing circuit 550 executes for example the media reading process and the jam determination process in place of the processing circuit 150. The processing circuit 550 includes a control circuit 551 and a determination circuit 552. These circuits may be independent integrated circuits, microprocessors, or firmware.

The control circuit 551 is an example of a control unit and has functions similar to those of the control unit 151. The control circuit 551 receives an operation signal from the operation device 105 or the interface device 132 and a first detection signal from the first sensor 111. The control circuit 551 controls the motor 131 based on the received signals. Further, the control circuit 551 acquires an input image from the imaging device 118 and outputs the input image to the interface device 132. Further, the control circuit 551 reads the determination result of the jamming of a medium from the storage device 140 and controls the motor 131, the interface device 132, or the display device 106 to execute error handling in accordance with the read determination result.

The determination circuit 552 is an example of a determination unit and has functions similar to those of the determination unit 152. The determination circuit 552 receives a first detection signal, a second detection signal, and/or a third detection signal from the second sensor 114, 314, or 414, the third sensor 117, and/or the fourth sensor 221, respectively. The determination circuit 552 determines whether a media jam occurs based on the received signals and stores the determination result in the storage device 140. Further, the determination circuit 552 controls the interface device 132 or the display device 106 to notify the user of a warning.

As described in detail above, the media conveying apparatus including the processing circuit 550 can also more accurately determine whether a media jam occurs.

In a media conveying apparatus, it is required to more accurately determine whether a media jam occurs.

According to one or more embodiments, a media conveying apparatus, a control method, and a non-transitory computer-executable medium can more accurately determine whether a media jam occurs.

The objects and advantages of the present invention are recognized and achieved by the elements particularly pointed out in the appended claims and the combinations thereof. It is to be understood that both the above-described general description and the detailed description described below are exemplary and explanatory only and are not intended to restrict the claimed invention.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

1. A media conveying apparatus comprising:
a media tray;
a feed roller to feed a medium;
a first media sensor located downstream from the feed roller in a media conveyance direction, and inside of a side wall of a media conveyance path and outside of a maximum size media supported by the media conveying apparatus placed on the media tray in a direction perpendicular to the media conveyance direction;
a second media sensor located downstream from the first media sensor in the media conveyance direction; and
circuitry configured to execute error handling based on a detection result of the medium by the first media sensor and a detection result of the medium by the second media sensor.

2. The media conveying apparatus of claim 1, wherein
the second media sensor is located inside of the first media sensor in the direction perpendicular to the media conveyance direction, and
the circuitry is configured to execute error handling when the first media sensor detects the medium after the second media sensor detects the medium.

3. The media conveying apparatus of claim 1, wherein
the second media sensor is located at a position that is the same as a position of the first media sensor in the direction perpendicular to the media conveyance direction, and
the circuitry is configured to execute error handling when the first media sensor does not detect the medium and the second media sensor detects the medium.

4. The media conveying apparatus of claim 1, wherein the first media sensor includes an applying member to apply a force inward in the direction perpendicular to the media conveyance direction to the medium in response to the medium coming into contact with the first media sensor.

5. The media conveying apparatus of claim 1, further comprising an imaging sensor to image the medium being conveyed,
wherein the first media sensor is located outside of the imaging sensor or at an end position of the imaging sensor in the direction perpendicular to the media conveyance direction.

6. A control method for controlling a media conveying apparatus, the control method comprising:
feeding a medium with a feed roller; and
executing error handling based on a detection result of the medium by a first media sensor and a detection result of the medium by a second media sensor,
wherein,
the first media sensor is located downstream from the feed roller in a media conveyance direction, and inside of a side wall of a media conveyance path and outside of a maximum size media supported by the media conveying apparatus placed on a media tray in a direction perpendicular to the media conveyance direction, and
the second media sensor is located downstream from the first media sensor in the media conveyance direction.

7. A non-transitory computer-executable medium storing a plurality of instructions which, when executed by one or more processors of a media conveying apparatus, causes the one or more processors to perform a method, the method comprising:
executing error handling based on a detection result of a medium by a first media sensor and a detection result of the medium by a second media sensor,
wherein,
the first media sensor is located downstream from a feed roller to feed a medium in a media conveyance direction, and inside of a side wall of a media conveyance path and outside of a maximum size media supported by the media conveying apparatus placed on a media tray in a direction perpendicular to the media conveyance direction, and
the second media sensor is located downstream from the first media sensor in the media conveyance direction.
